(19) United States
(12) Patent Application Publication
(10) Pub. No.: US 2016/0097856 A1
(43) Pub. Date: Apr. 7, 2016

(54) ACOUSTIC APPARATUS WITH DUAL MEMS DEVICES

(71) Applicant: Knowles Electronics, LLC, Itasca, IL (US)

(72) Inventors: Sarmad Qutub, Des Plaines, IL (US); William Ryan, Villa Park, IL (US); Martin Volk, Willowbrook, IL (US); Wade Conklin, Chicago, IL (US)

(21) Appl. No.: 14/872,887

(22) Filed: Oct. 1, 2015

Related U.S. Application Data
(60) Provisional application No. 62/058,992, filed on Oct. 2, 2014.

(51) Int. Cl. G01S 15/10; G01S 7/521

(52) U.S. Cl. CPC G01S 15/10; G01S 7/521

(57) ABSTRACT

In accordance with one aspect of the disclosure, an acoustic apparatus is provided including a first transducer, a second transducer, a signal generator coupled to the first transducer, and a proximity detection module coupled to the second transducer. A buffering module is coupled to the first and second transducers and is configured to process analog signals received from the second transducer.

### CROSS-REFERENCE TO RELATED APPLICATION

This patent claims benefit under 35 U.S.C. §119(e) to U.S. Provisional Application No. 62/058,992 entitled “Acoustic Apparatus With Dual MEMS Devices” filed Oct. 2, 2014, the content of which is incorporated herein by reference in its entirety.

### TECHNICAL FIELD

This application relates to acoustic devices and, more specifically, to using ultrasonic approaches in these devices.

### BACKGROUND OF THE INVENTION

Different types of acoustic devices have been used through the years. One type of acoustic device is a microphone, and one type of microphone is a microelectromechanical system (MEMS) microphone. In a MEMS microphone, a MEMS die includes a diaphragm and a back plate. The MEMS die is often disposed a substrate (or base) and is enclosed by a housing (e.g., a cup or cover with walls). A port may extend through the substrate (for a bottom port device) or through the top of the housing (for a top port device). In any case, sound energy traverses through the port, moves the diaphragm and creates a changing potential with respect to the back plate, which creates an electrical signal. An application specific integrated circuit (ASIC) may perform further processing on the signal. Microphones are deployed in various types of devices such as personal computers or cellular phones.

Proximity detectors have also been used with various types of devices. For example, a proximity detector may when used with a cellular phone to sense the presence of a user. Proximity detectors typically use infrared detectors. Unfortunately, these types of detectors consume a large amount of power, require multiple components (an infrared LED and an infrared sensor), and occupy a large physical footprint. This becomes a particular problem when the proximity detectors are used in conjunction with electronic devices where a small size and low power consumption is an important design consideration.

These problems have resulted in some user dissatisfaction with previous approaches.

### BRIEF DESCRIPTION OF THE DRAWINGS

For a more complete understanding of the disclosure, reference should be made to the following detailed description and accompanying drawings wherein:

FIG. 1A comprises a block diagram of an acoustic apparatus with an ultrasonic detector according to various embodiments of the present invention;

FIG. 1B comprises a block diagram of an acoustic apparatus with an ultrasonic detector according to various embodiments of the present invention;

FIG. 1C comprises a block diagram of an acoustic apparatus with an ultrasonic detector according to various embodiments of the present invention;

FIG. 2A comprises one example of a state transition diagram of an acoustic apparatus with an ultrasonic detector according to various embodiments of the present invention;

FIG. 2B comprises another example of a state transition diagram of an acoustic apparatus with an ultrasonic detector according to various embodiments of the present invention;

FIG. 3 comprises a flowchart of aspects of the operation of an acoustic apparatus with an ultrasonic detector according to various embodiments of the present invention;

FIG. 4 comprises a flowchart of aspects of the operation of an acoustic apparatus with an ultrasonic detector according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

In the present approaches, a dual-purpose ultrasonic transceiver microphone is provided. More specifically, multiple MEMS devices or transducers are utilized as transceivers. Built-in circuitry or intelligence is provided that determines the time of flight (of the ultrasonic signal from the MEMS device to the object, and the time the reflected signal takes to return to the MEMS device) and ultimately the distance of a physical object or interferer. This functionality can be disposed on an application specific integrated circuit with a logic controller/interface that allows communications (e.g., proximity output, microphone output, command and control information, and mode switching) with external controllers. Although many of the transducers utilized herein are MEMS transducers, it will be understood that any type of transducer (e.g., (MEMS, piezoelectric, or some other type) may be used.

Advantageously, the present approaches allow for a lower part count for proximity detection functions as compared to previous approaches. Additionally, a smaller footprint is provided for the proximity detection functionality as compared to the footprint provided by previous devices. The present approaches also result in lower power consumption extending battery life and lower cost to the overall build of materials.

Additionally, using acoustic transducers for proximity detection utilizes less power than previous approaches. Integrating the proximity detector into the acoustic port, and the microphone eliminates the need for infrared light emitting diodes (LEDs) and sensors and related circuitry in electronics thereby reducing cost. This simplifies the architecture of electronic devices and leaves additional unoccupied space on the PCB that will allow smaller designs, thinner designs, or the integration of other wanted components.

In the present approaches, the microphone can be used simultaneously for acoustic noise cancellation (ANC) and proximity detection since the transducer switches between transmission and detection. The present approaches could be used for phones not using a third microphone for noise cancellation, or wearable electronics that only desire proximity detection integration.

In many of these embodiments, an apparatus includes a first transducer and a second transducer. A first transducer is configured to transmit ultrasonic signals. The first transducer (or a second transducer) is configured to detect the reflection of these signals. The second transducer also receives audible acoustic signals and converts these signals to electrical signals.

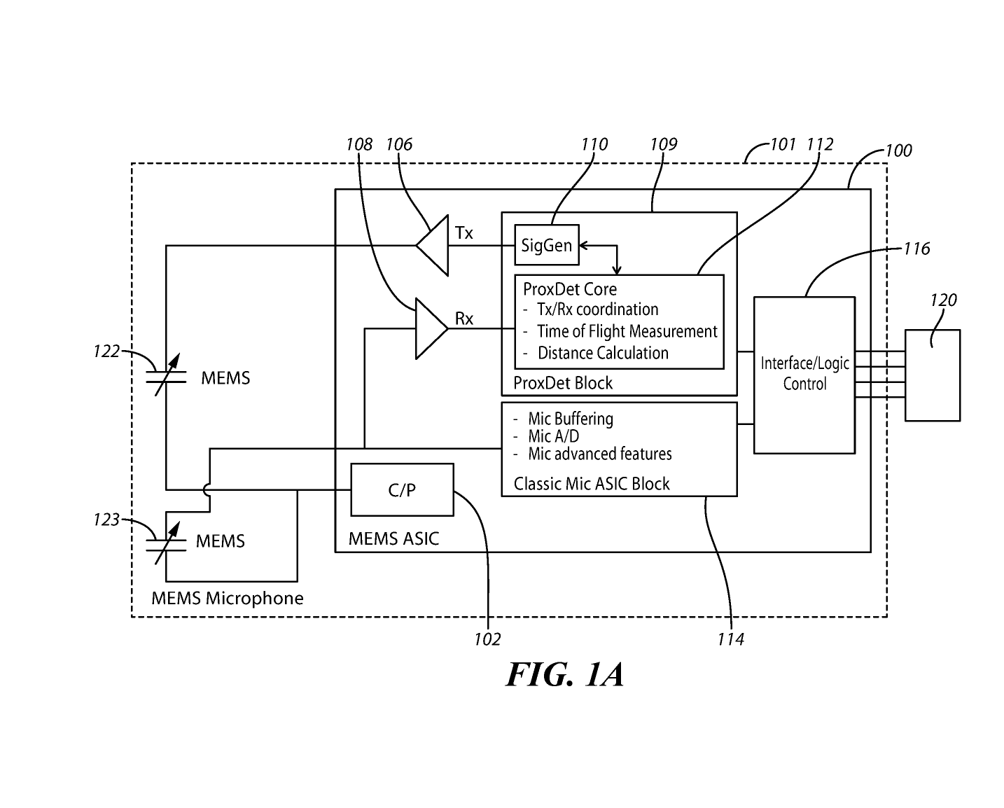

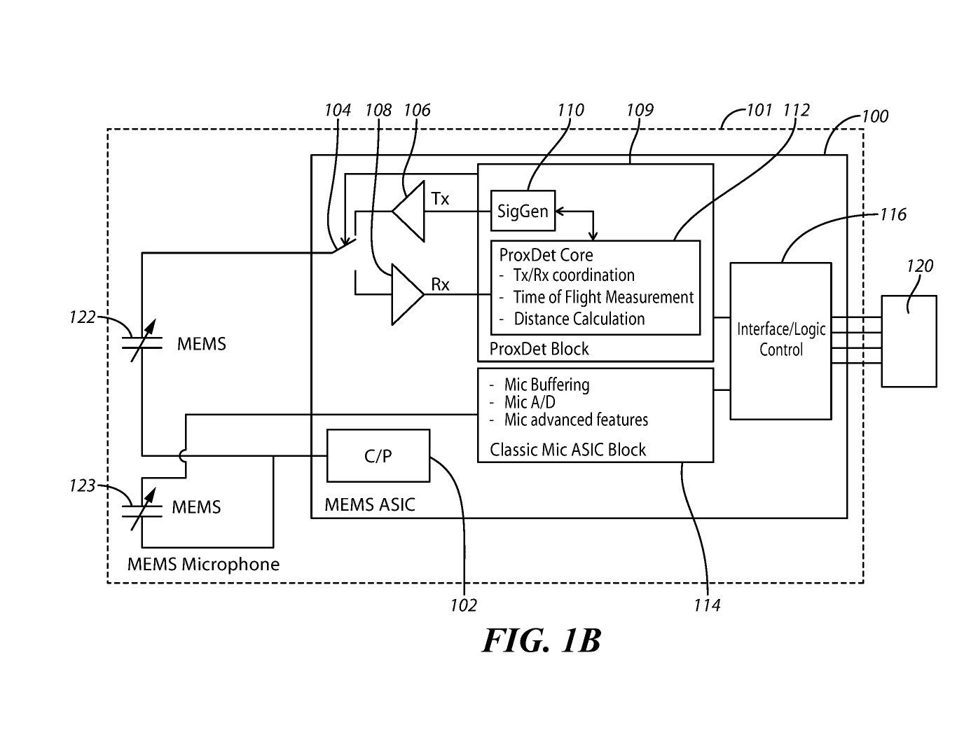

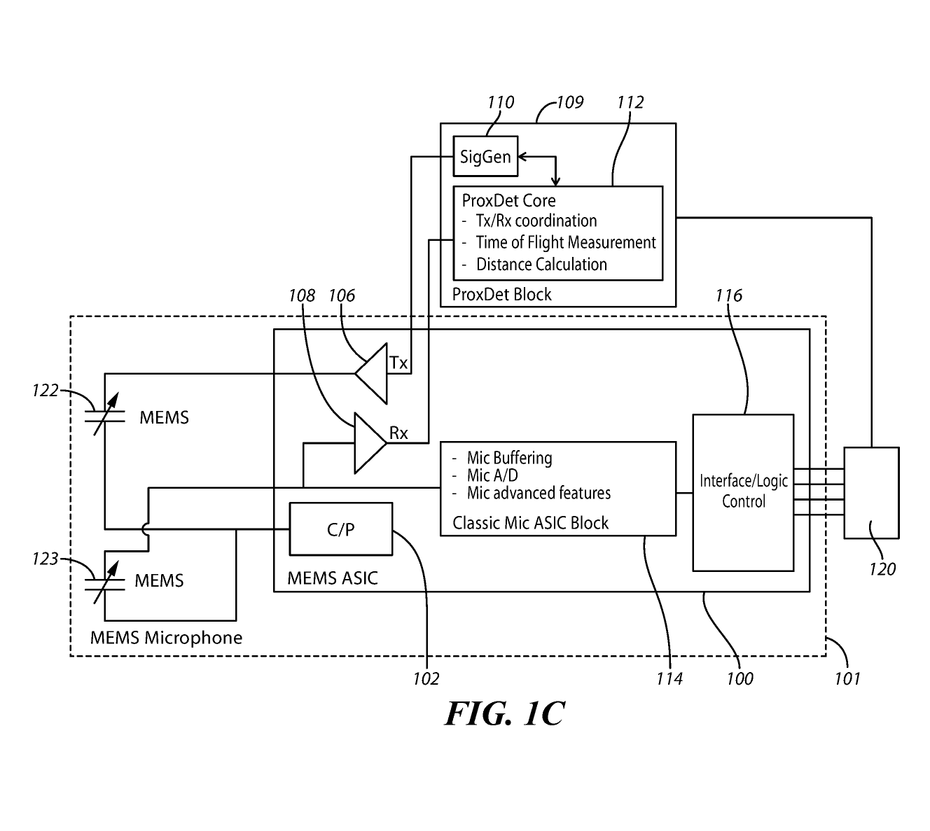

Referring now to FIG. 1A, one example of an apparatus is described. A microelectromechanical system (MEMS) dual-purpose application specific integrated circuit (ASIC) 100 includes a charge pump 102, a amplifier 106, a buffer 108, a proximity detection block or module 109 (including a signal generator 110 and a proximity detection core 112), and a buffering module 114, and an interface logic control module 116. The ASIC 100 is coupled to a system controller 120 and a first MEMS device 122 and a second MEMS device 123 (or any other type of transducer such as a piezoelectric transducer to give one example). It will be appreciated that if a piezoelectric sensor is used, the charge pump is not needed. The system controller 120 may also be external to the ASIC 100.

The MEMS devices 122, 123 and the ASIC 100 may be incorporated into a MEMS microphone 101. In these regards, the ASIC 100 and MEMS devices 122 and 123 may be disposed on a base and covered by a lid or cover. The lid, cover, or base may have a port allowing sound and reflected sound to enter the microphone, and allow ultrasonic signals to exit the microphone 101.

The charge pump 102 provides current, voltage, and/or power to operate the MEMS devices 122 and 123. Ultrasonic signals are transmitted (via the amplifier 106) to the MEMS device 122. Signals (reflected ultrasonic signals or signals in the normal audio range) are input (via the buffer 108 or directly to buffering module 114). The amplifier 106 may be any combination of hardware and/or software configured to amplify signals and the buffer 108 may be any combination of hardware and/or software configured to receive signals from the MEMS device 123. Although the MEMS devices 122 and 123 are used herein, it will be understood that any other type of transducers (e.g., piezoelectric, or some other type) may also be used.

The proximity detection block or module 109 may be any combination of hardware and/or software configured to perform the proximity detection function. In the ultrasonic mode of operation, ultrasonic signals are transmitted, their reflections received from an object of interest, and a distance is calculated to the object of interest (e.g., the face of a user). The signal generator 110 generates ultrasonic signals for transmission (via the amplifier 106) to the MEMS device 122 when operating in the ultrasonic mode of operation.

The core 112 also makes a time-of-flight measurement, for example, calculating time-of-flight from the time the signal is transmitted until the time the reflected signal is received. In another example, the core 112 could determine proximity by measuring the amplitude of the reflected signal. From the time-of-flight measurement and calculation, a distance to the object can be determined by the core 112. This distance can be transmitted from the core 112 through the interface logic control module 116 to the system controller 120. Other examples are possible.

The buffering module 114 may perform microphone audio processing on audio signals received from the MEMS device 123. For example, this processing may include gain adjustments, phase adjustments, information retrieval, or noise removal. Other examples are possible.

The interface logic control module 116 serves an interface between the external devices (e.g., the system controller 120) and the internal blocks/modules of the ASIC 100. The interface logic control module 116 may have individual outputs for the microphone function and the proximity detection function such as PDM and I2C respectively, or the two functions may share a single output by means of multiplexing or another method.

The system controller 120 may be a component in an electronic device. The customer device may be a cellular phone, a personal computer, or a tablet to mention a few examples. In one example, the system controller 120 issues commands to the apparatus 100 that instruct the apparatus to enter into an ultrasonic transmission/detection or a normal audio reception mode.

The MEMS devices 122 and 123 each include a diaphragm and a back plate and couple to the charge pump 102. The MEMS device 122 can be driven by the amplifier to transmit ultrasonic signals.

In one example of the operation of the system of FIG. 1A and when in an ultrasonic mode of operation, ultrasonic signals are transmitted from the signal generator 110, to the amplifier 106, to the MEMS device 122. The MEMS device 122 is actuated to transmit the signals. The reflected signals (received at the MEMS device 123) are to the buffer 108, then to the proximity detection block or module 109, where the proximity detection core 112 processes the reflected signals.

In another mode of operation, the MEMS device 123 further receives human audible (or sonic) acoustic signals. These signals are received directly at the buffering module 114.

The modes may be controlled by commands received from the system controller 120. In these regards, the system controller 120 issues a command as to which mode of operation to operate. The commands are transmitted through the interface/logic control module 116 to the proximity detection core 112.

Various types of information are obtained by the ASIC 100 and can be output to external devices such as the system controller 120, microprocessors, or other SoC (system on chip). For instance, digital information representing the audio signal may be transmitted by the buffering module 114. The proximity detection core 112 may determine a distance to an object. All types of information are transmitted through the interface logic control module 116 to the system controller 120. This information can be multiplexed into a single interface port or there could be several ports/interfaces for various modes of operation (audible signals for functions as a mic and signals to control and communicate info from the proximity sensor mode, or both simultaneously)

In one example, the apparatus 100 operates with signals having frequencies above the human audible range. The range of detection may be up to 500 mm. Other values and ranges are possible.

It will be understood that the approaches described herein operate with signals having frequencies beyond the human audible range. This may be any signal that is inaudible to human beings which, while most are above 20 kHz, can be below 20 kHz. The range of detection may be up to 500 mm. Other values and ranges are possible. It will be understood that the approaches described herein operate with audible signals in the approximately 20 Hz-20 kHz range.

Referring now to FIG. 1B, another example of an apparatus is described. A microelectromechanical system (MEMS) dual-purpose application specific integrated circuit (ASIC) 100 includes a charge pump 102, a switch 104, an amplifier 106, a buffer 108, a proximity detection block or module 109 (including a signal generator 110 and a proximity detection core 112), and a buffering module 114, and an interface logic control module 116. The ASIC 100 is coupled to an system controller 120 and a first MEMS device 122 and second MEMS device 123 (or any other type of transducer such as a piezoelectric transducer to give one example). It will be appreciated that if a piezoelectric sensor is used, the charge pump is not needed. The system controller 120 may also be external to the ASIC 100.

The MEMS devices 122 and 123, and ASIC 100 may be incorporated into a MEMS microphone 101. In these regards, the ASIC 100 and MEMS devices 122 and 123 may be disposed on a base and covered by a lid or cover. The lid, cover, or base may have a port allowing sound and reflected sound to enter the microphone, and allow ultrasonic signals to exit the microphone 101.

The charge pump 102 provides current, voltage, and/or power to operate the MEMS devices 122 and 123. The switch 104 controls whether ultrasonic signals are transmitted (via the amplifier 106) to the MEMS device 122, or whether ultrasonic signals are input (via the buffer 108). The amplifier 106 may be any combination of hardware and/or software configured to transmit signals and the buffer 108 may be any combination of hardware and/or software configured to receive signals from the MEMS device 122. Although the MEMS devices 122 and 123 is used herein, it will be understood that any other type of transducer (e.g., piezoelectric, or some other type) may also be used.

The proximity detection block or module 109 includes hardware and/or software for operating in the ultrasonic mode of operation. In the ultrasonic mode of operation, ultrasonic signals are transmitted, their reflections received from an object of interest, and a distance is calculated to the object of interest (e.g., the face of a user). The signal generator 110 generates ultrasonic signals for transmission (via the amplifier 106) to the MEMS device 122 when operating in the ultrasonic mode of operation.

The proximity detection core 112 includes hardware and/or software that controls the switch 104. The system controller 120 sends commands to the interface logic control module 116 and the interface logic control module 116 instructs the core 112 to operate the switch in a first position (for ultrasonic transmission of signals) or in a second position (for receiving reflected ultrasonic signals).

The core 112 also makes a time-of-flight measurement, for example, calculating time-of-flight from the time the signal is transmitted until the time the reflected signal is received. In another example, the core 112 could determine proximity by measuring the amplitude of the reflected signal. From the time-of-flight measurement and calculation, a distance to the object can be determined by the core 112. This distance can be transmitted from the core 112 through the interface logic control module 116 to the system controller 120. Other examples are possible.

The buffering module 114 may perform microphone audio processing on audio signals received from the MEMS device 123. For example, this processing may include amplitude adjustments, phase adjustments, information retrieval, or noise removal. Other examples are possible.

The interface logic control module 116 serves an interface between the external devices (e.g., the system controller 120) and the internal blocks/modules of the ASIC 100.

The system controller 120 may be a component in a customer device. The customer device may be a cellar phone, a personal computer, or a tablet to mention a few examples. In one example, the system controller 120 issues commands to the apparatus 100 that instruct the apparatus to enter into a ultrasonic transmission/detection or a normal audio reception mode.

The MEMS devices 122 and 123 each include a diaphragm and a back plate and couple to the charge pump 102. The MEMS device 122 is driven by the amplifier to transmit ultrasonic signals, and receives and senses reflected ultrasonic signals. The MEMS device 123 receives and senses audio signals in the audio range.

In one example of the operation of the system of FIG. 1B and when in an ultrasonic mode of operation, ultrasonic signals are transmitted from the signal generator 110, to the amplifier 106, across the switch 104 (being in a first position allowing signals to be output) to the MEMS device 122. The MEMS device 122 is actuated to transmit the signals. The switch 104 is subsequently placed in a second position allowing the reflected signals (received at the MEMS device 122) to be sent across the switch 104 to the buffer 108, then to the proximity detection block or module 109, where the proximity detection core 112 processes the reflected signals.

In a second mode of operation, the MEMS device 123 further receives human audible acoustic signals.

The modes may be controlled by commands received from the system controller 120. In these regards, the system controller 120 issues a command as to which mode of operation to operate. The commands are transmitted through the interface/logic control module 116 to the proximity detection core 112. The proximity detection core 112 issues commands that actuate the switch 104.

Various types of information are obtained by the ASIC 100 and can be output to external devices such as the system controller 120. For instance, digital information representing the audio signal may be transmitted by the buffering module 114. The proximity detection core 112 may determine a distance to an object. All types of information are transmitted and received through the interface logic control module 116 to the system controller 120.

In one example, the apparatus 100 operates with ultrasonic signals. The range of detection may be up to 500 mm. Other values and ranges are possible.

It will be understood that the approaches described herein also operate with audible or sonic signals in the approximately 20 Hz-20 kHz range. As used herein, ultrasonic signals are acoustic signals having a frequency above the human ear's audibility limit of around 20 kHz. This may be any signal that is inaudible to human beings which, while most are above 20 kHz, can be below 20 kHz

It will be appreciated that the microphones of FIG. 1A and FIG. 1B have a cover (or lid) and that the components reside on a substrate. The lid or substrate has openings or ports allowing sound energy to enter the interior of the microphone. In one example, as single port is used allowing sound energy to be received at each of the MEMS devices 122 and 123. In another example, two ports are used. In this case, one port is used to receive and direct sound to the first MEMS device 122 and the other port is used to receive and direct sound to the second MEMS device 123. In these cases, the MEMS device 122 and 123 couple to the port (e.g., are disposed over the port).

With reference to FIG. 1C, another apparatus is provided that is similar in many respects to the apparatus of FIG. 1A. One difference between the two is that the proximity detection block or module 109 and signal generator 110 and proximity detection core 112 thereof are all external to a microphone 101. In other embodiments, one of the signal generator 110 and the proximity detection core 112 may be included with the ASIC 100 and the other of the signal generator 110 and the proximity detection core 112 may be external to the microphone 101. It will be appreciated that, with respect to FIGS. 1A, 1B, and 1C, one or more of the elements of the apparatuses can be external to the microphone 101, external to the ASIC 100 but a component of the microphone 101, or other arrangement as desired for a particular application.

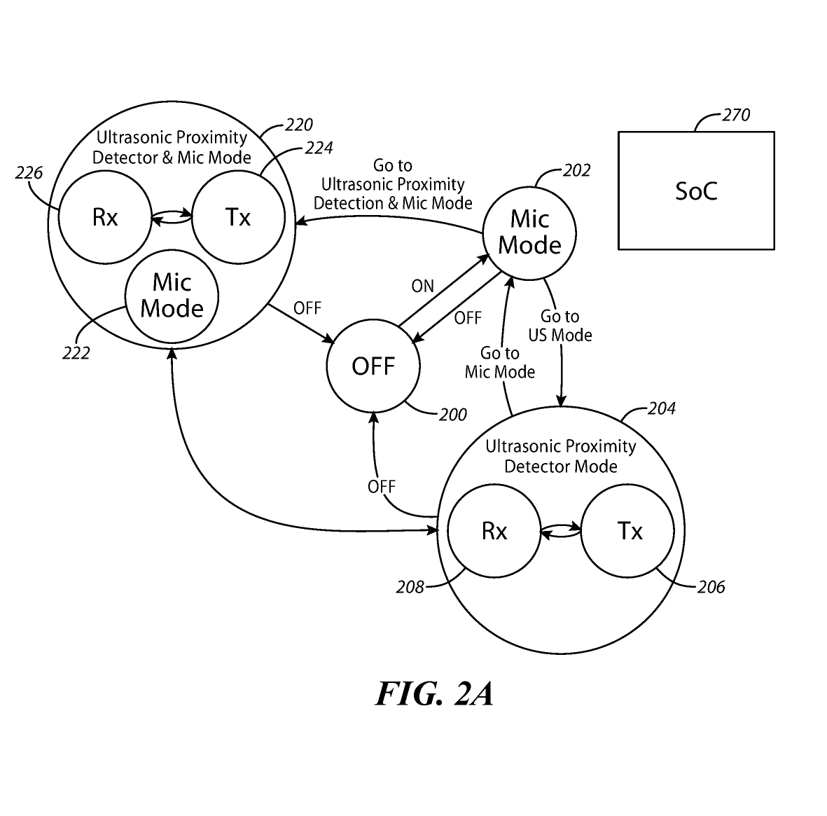

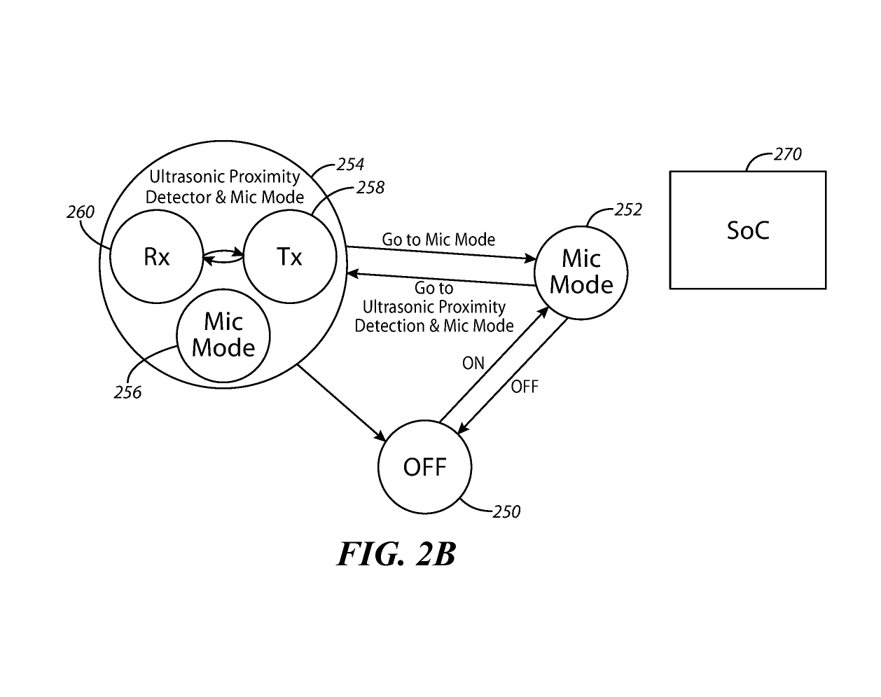

Referring now to FIG. 2A, one example of the operation of a system with the multiple transducers is described. It will be appreciated that this is one example of a state transition diagram and that other examples are possible.

Initially, the system may be in an off state 200 where the ASIC (that is connected to the multiple transducers) is waiting for commands or signals from SoC 270 to activate the device. Activation of the microphone causes the state to transition to a microphone mode state 202.

State 202 is a normal audio processing state. In this state 202, audio signals in the normal audio reception range are received and processed. The processed signals or information concerning these signals may be returned to the external controller 270. If a command or signal is received to enter ultrasonic proximity detection mode, the state changes to the ultrasonic proximity detection state 204.

In the state 204, ultrasonic signals are sent from a transducer (in a sub-state 206) and the reflected ultrasonic signal is received back (in a sub-state 208). A distance determination based upon the time of flight of the transmitted and received signal is made and this may be reported to an external controller 210. If a command or signal is received to go back into the normal audio processing mode, control returns to state 202. If a command or signal is received to turn off the microphone, then control returns to state 200.

If in state 202 a command is received to go to ultrasonic proximity detection and microphone state, control goes to state 220. In this state, the system is simultaneously listening for audio signals (Step 222), and transmitting ultrasonic signals (step 224) and receiving reflected ultrasonic signals (step 226). An off command causes a return to off state 200. It is also possible to transition between states 204 and 220.

Referring now to FIG. 2B, another example of the operation of a system with the multiple transducers is described. It will be appreciated that this is one example of a state transition diagram and that other examples are possible.

Initially, the system may be in an off state 250 where the ASIC (that is connected to the multiple transducers) is waiting for commands or signal to activate the device. Activation of the microphone causes the state to transition to a microphone mode state 252.

State 252 is a normal audio processing state. In this state 252, audio signals in the normal audio reception range are received and processed. The processed signals or information concerning these signals may be returned to the external controller 270.

If in state 252 a command is received to go to ultrasonic proximity detection and microphone state, control goes to state 254. In this state 254, the system is simultaneously listening for audio signals (Step 256), and transmitting ultrasonic signals (step 258) and receiving reflected ultrasonic signals (step 260). An off command causes a return to off state 250. A command to return to mic mode will cause a return to state 252.

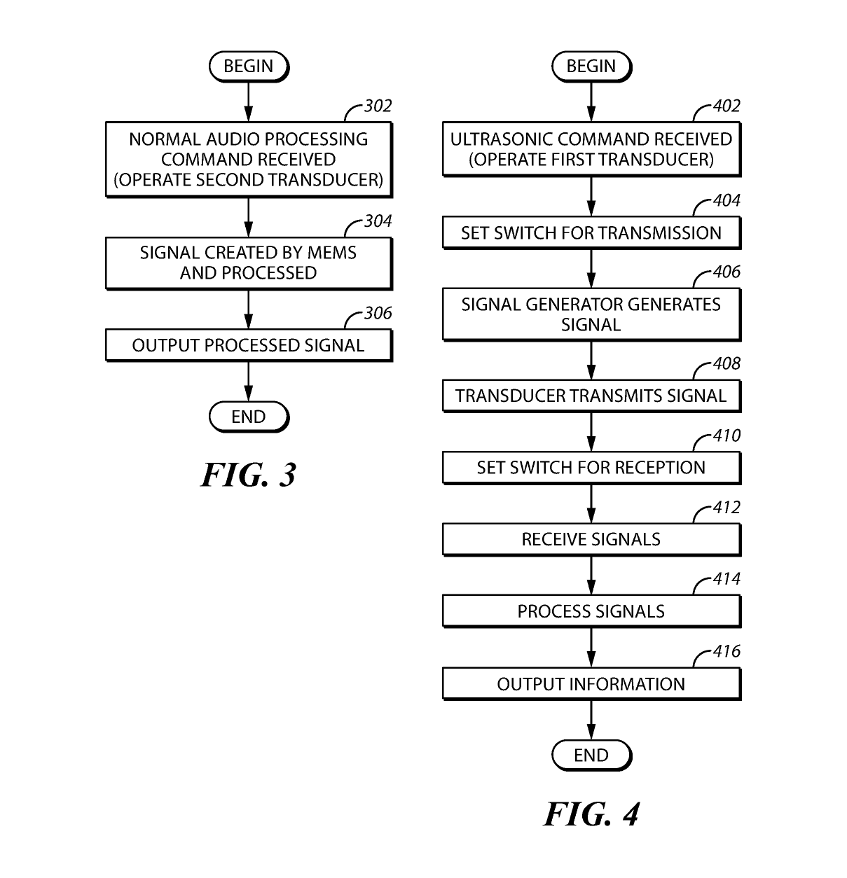

Referring now to FIG. 3, one example of the operation of the apparatus as a microphone is described. It will be appreciated that the example of FIG. 3 may utilize the circuitry of FIG. 1B and this is reflected in the description below. At step 302, a command is received at an interface (e.g., the interface logic control module 116) from an external device (e.g., the system controller 120) and, in this case, the command is to operate the apparatus (e.g., ASIC 100) in normal audio processing mode.

When the command is received, at step 304 the sound pressure and the MEMS device create a signal, which is routed via the buffering module 114 to be processed by the apparatus. At step 306, the processed signal may be output, for example, for further processing by an external controller (e.g., by the system controller 120) for example.

Referring now to FIG. 4, one example of the operation of the apparatus as an ultrasonic proximity detector is described. It will be appreciated that the example of FIG. 4 may utilize the circuitry of FIG. 1B and this is reflected in the description below.

At step 402, a command is received from the interface (e.g., the interface logic control module 116) from an external device (e.g., the system controller 120) telling the apparatus (e.g., ASIC 100) to go into ultrasonic mode of operation.

At step 404, the switch (e.g., switch 104 of FIG. 1) is switched to allow the amplifier (e.g., the amplifier 106 of FIG. 1) to transmit a signal. At step 406, the signal generator (e.g., signal generator 110 of FIG. 1) generates an ultrasonic signal. At step 408, the ultrasonic signal is transmitted via an amplifier (e.g., amplifier 106).

At step 410, the switch (e.g., switch 104) is switched to a position to allow received signals to be input via a buffer (e.g., buffer 108). At step 412, the received signals are received and passed to the processing software and/or circuitry (at the core 112). At step 414, processing occurs to determinate a flight time of the signal and then a distance. At step 416, this information may be output to an external entity such as an external controller (e.g., system controller 120) for further processing via an interface (e.g., interface logic control module 116).

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An acoustic apparatus, comprising:
a first transducer;
a second transducer;
a signal generator coupled to the first transducer;
a proximity detection module coupled to the first and second transducers;
a buffering module coupled to the second transducer, the buffering module configured to process analog signals received from the second transducer;
wherein in a first mode, the signal generator drives the first transducer to produce ultrasonic signals;
wherein in a second mode, the ultrasonic signals are reflected by an object and returned as reflected ultrasonic signals to the second transducer;
wherein in the a third mode, the reflected ultrasonic signals are processed by the proximity detection module to obtain a distance parameter, the distance parameter indicative of a distance between the apparatus and the object;
wherein in a fourth mode, the second transducer receives human-hearable audio signals.

2. The apparatus of claim 1, wherein the first transducer and the second transducer are a micro electro mechanical system (MEMS) transducer or a piezo electronic transducer.

3. The apparatus of claim 1, wherein the signal generator and the proximity detection module are disposed at a microphone.

4. The apparatus of claim 1, wherein the signal generator and the proximity detection module are disposed outside a housing of a microphone.

5. The apparatus of claim 1, wherein outputs of the buffer module and the proximity detection module are digital.

6. The apparatus of claim 1, wherein the apparatus further includes a charge pump coupled to at least one of the first transducer and the second transducer.

7. The apparatus of claim 1, wherein the distance parameter comprises a time-of-flight parameter, a signal amplitude parameter, or a correlative factor of a pseudo random signal.

8. The apparatus of claim 1, wherein the apparatus is disposed at a mobile phone, a tablet, an appliance, a personal computer, or a wearable electronic device.

9. The apparatus of claim 1, wherein the proximity detection module includes the signal generator.

10. A method of operating an apparatus, the method comprising:
driving a first transducer by a signal generator to produce ultrasonic signals;
reflecting the ultrasonic signals from an object as reflected ultrasonic signals;
receiving the reflected ultrasonic signals at a second transducer;
processing the received reflected ultrasonic signals by a proximity detection module to obtain a distance parameter, the distance parameter indicative of a distance between the apparatus and the object;
receiving at the second transducer human-hearable audio signals.

11. The method of claim 10, wherein the first transducer and the second transducer are a micro electro mechanical system (MEMS) transducer or a piezo electronic transducer.

12. The method of claim 10, wherein the signal generator and the proximity detection module are disposed at a microphone.

13. The method of claim 10, wherein the signal generator and the proximity detection module are disposed outside the housing of a microphone.

14. The method of claim 10, wherein processing the received reflected ultrasonic signals by the proximity detection module includes outputting a digital signal from the proximity detection module.

15. The method of claim 10, further comprising coupling a charge pump to at least one of the first transducer and the second transducer.

16. The method of claim 10, wherein the distance parameter comprises a time-of-flight parameter, a signal amplitude parameter, or a correlative factor of a pseudo random signal.
